(19) United States
(12) Patent Application Publication
(10) Pub. No.: US 2026/0246014 A1
(43) Pub. Date: Aug. 20, 2026

(54) THERMAL REGULATION DEVICE FOR COOLING ELECTRICAL ENERGY STORAGE MEMBERS

(71) Applicant: VALEO SYSTEMES THERMIQUES, Le Mesnil-Saint-Denis (FR)

(72) Inventors: Aurelie BELLENFANT, Le Mesnil-Saint-Denis Cedex (FR); Fethy DJALLAL, Le Mesnil- Saint-Denis Cedex (FR); Julien VERON, Le Mesnil- Saint-Denis Cedex (FR); Marc HERRY, Le Mesnil- Saint-Denis Cedex (FR)

(73) Assignee: VALEO SYSTEMES THERMIQUES, Le Mesnil-Saint-Denis (FR)

(21) Appl. No.: 19/159,492

(22) PCT Filed: Feb. 28, 2024
(86) PCT No.: PCT/EP2024/055128

§ 371 Date: Aug. 25, 2025

(30) Foreign Application Priority Data
Mar. 2, 2023 (FR) FR2301952

(51) Int. Cl. H01M 10/6557; H01M 10/613; H01M 10/615; H01M 10/643; H01M 10/6568

(52) U.S. Cl. CPC H01M 10/6557; H01M 10/613; H01M 10/615; H01M 10/643; H01M 10/6568

(57) ABSTRACT

A thermal regulation device for electric battery cells includes a distribution tank having a fluid intake chamber and a fluid return chamber. A tube with two fluid circulation assemblies is rigidly secured by a bridge of material, one in communication with the intake chamber and the other with the return chamber, the bridge of material forming at least one absence of material between the two assemblies. The distribution tank includes a rib separating the intake chamber from the return chamber, partially housed in the absence of material. The bridge of material includes a notch opening out on an end face of the tube, the rib including a longitudinal bulge housed partially in the notch.

The present invention relates to the fields of thermodynamics and mechanics, and more specifically concerns a thermal regulation device for an electrical energy storage system.

Such electrical energy storage systems are used in particular in electric or hybrid vehicles which are equipped, in addition to their service batteries intended to supply their on-board networks, with high-voltage batteries, of around 200 to 800 volts, intended in particular to supply their electric traction motors and other high-voltage devices. These high-voltage electrical energy storage systems are generally composed of electrical energy storage members, also referred to as electrical energy storage cells, grouped together electrically in battery packs, for example placed under the floors of these vehicles.

In light of the power supplied by these high-voltage energy storage systems, thermal regulation devices are necessary to cool the energy storage members of which they are composed, since too great an increase in their temperature could damage them to the point of causing their destruction. These thermal regulation devices can also be used to warm up energy storage members when they are at an excessively low temperature, for example when starting vehicles in very cold weather, since at low temperatures their performance is generally too poor to allow optimal operation of these vehicles.

In battery packs in which electrical energy storage cells are arranged vertically one beside the other in such a way as to form a plurality of successive rows of cells, it is notably known practice to have thermal regulation devices each having a tube which is placed between two rows of cells and within which the heat transfer fluid is able to circulate. When these cells are cylindrical in shape, the tube has corrugations allowing maximum surface area for contact with each cell to which it is adjacent. The contact between the tube and the cells allows heat energy to be discharged, or supplied, via the heat transfer fluid. To manage the intake and discharge of the heat transfer fluid, a fluid distribution tank is arranged at one end of the tube and heat transfer fluid intake and outlet pipes are connected to this distribution tank. The heat transfer fluid entering through the intake pipe at least partially pours into the tube via an intake chamber formed in the distribution tank, whereas the fluid exiting the tube, after having recovered heat energy for example to lower the temperature of the battery pack, pours into the outlet pipe via a return chamber also formed in the distribution tank.

In order to allow the heat transfer fluid to circulate within the tube, the latter is pierced with a multitude of circulation channels along which the heat transfer fluid circulates from one longitudinal end of the tube to the other. These channels are grouped into two circulation assemblies in order to allow the circulation of heat transfer fluid in a first direction, away from the distribution tank, separately to the circulation of heat transfer fluid in a second opposite direction. The intake chamber within the distribution tank should then be in fluidic communication with the first circulation assembly within the tube and the return chamber within the distribution tank should be in fluidic communication with the second circulation assembly within the tube, ensuring that there is no direct communication from the intake chamber to the return chamber, so as to for example prevent heated heat transfer fluid from passing, during its passage through the tube, from the second circulation assembly to the intake chamber and being re-injected hot into the tube.

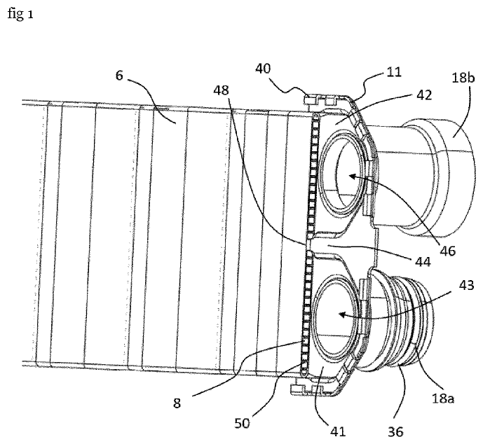

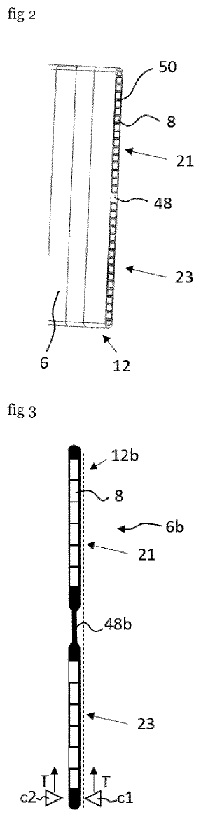

The inventors have designed such a regulation device, described in patent application FR3125636, shown partially in FIGS. 1 and 2, which comprises a tube 6, a distribution tank formed of two shells assembled one on top of the other in particular using hooking tabs 40, only one of the shells 11 being depicted in FIG. 1, in order to show the interior of the tube 6 and the intake and return chambers of the distribution tank. When the cold heat transfer fluid arrives via an inlet pipe 18b through an inlet port 46 into the intake chamber, which is delimited by two cavities 42 of the shells 11 assembled one on top of the other, it enters channels 8 of a first heat transfer fluid circulation assembly 21, which are open on an end face 12 of the tube 6, and takes heat energy from the cells of the energy storage system to be cooled. A return tank connected to the other end of the tube 6 brings the heated heat transfer fluid in channels 8 of a second circulation assembly 23, adjacent to the first circulation assembly 21 in the tube 6, to the end face 12 of the tube 6. The heated heat transfer fluid enters the return chamber, delimited by two cavities 41 of the shells 11 assembled one on top of the other, then leaves through an outlet port 43 in an outlet pipe 18a connected to the return chamber. In order to prevent the heat transfer fluid from passing from the intake chamber to the return chamber, these chambers are separated by a central wall 44 formed by a rib on each of the shells 11. These ribs are brought into contact with a sealing zone 48 provided on the end face 12 between the first circulation assembly 21 and the second circulation assembly 23.

As can be seen in FIG. 2, this sealing zone 48 is a strip of material taking up the entire thickness and width of the tube between the first circulation assembly 21 and the second circulation assembly 23. Since the tube 6 is formed by extrusion, in this thermal regulation device, this strip of material extends longitudinally over the entire length of the tube 6, and is therefore expensive in terms of material compared to its function. Furthermore, although the sealing zone 48 is thicker than a wall 50 delimiting two channels 8 of the same circulation assembly, it thermally transfers a lot of heat energy from the second circulation assembly 23 to the first circulation assembly 21, which is not desirable. Lastly, depending on the method chosen for assembling the tube and distribution tank, it is not always possible to bring the ribs of the shells into contact with the sealing zone 48.

To be specific, in a first assembly method, the end of the tube 6 is inserted in a complementary receiving portion of the distribution tank, thus ensuring sealing between the tube 6 and the distribution tank, this insertion being carried out until there is contact between the ribs and the sealing zone 48, before brazing the tube 6 to the distribution tank. In this first assembly method, it is necessary to consider the chain of dimensions between a first corrugation of the tube 6, that is to say the corrugation or undulation closest to the distribution tank, and the center of a pipe 18a, 18b for example, in order to be able on the one hand to ensure that the tube is pressed firmly against the cells and on the other hand to ensure that the distribution tank of this tube can be connected via the pipes to a neighboring distribution tank so that heat transfer fluid can circulate properly from one tube to the other. The manufacturing tolerance of the tube plus that of the distribution tank add up to a significant tolerance between the first corrugation of the tube 6 and the elements attached to the distribution tank such as the pipes 18a and 18b. However, this significant tolerance may be a problem when it comes to assembling the regulation device with another regulation device sharing the same heat transfer fluid intake duct and the same heat transfer fluid discharge duct, because their respective inlet and outlet pipes must be coaxial, while ensuring that the first corrugations of each of the regulation devices are indeed in contact with a cell of the energy storage system, proximal to the corresponding regulation device. If either of these conditions is not met, assembly may not be possible, or may not allow the regulation devices to function properly.

In a second assembly method, the end of the tube 6 is inserted in a complementary receiving portion of the distribution tank, thus ensuring sealing between the tube 6 and the distribution tank, until a longitudinal end of the shells 11 reaches a stop external to the regulation device, this external stop ensuring that the longitudinal end of the shells 11 is at a predetermined distance from the first corrugation of the tube 6. This second assembly method allows better control of the distance between the pipes 18a, 18b of the distribution tank and the first corrugation, eliminating a link in the chain of dimensions and therefore reducing the necessary tolerance between the center of a pipe 18a, 18b and the first corrugation, which does not depend on a manufacturing tolerance between the first corrugation and the end face 12 of the tube 6, unlike the first assembly method. However, this second assembly method does not guarantee that the ribs 44 of the distribution tank are in contact with the sealing zone 48 and therefore a slight internal leak between the channels 8 of the first circulation assembly 21 and the channels 8 of the second circulation assembly 23 is possibly created.

The problem of thermal conductivity between the two circulation assemblies 21, 23 could be solved by forming these two circulation assemblies in two different tubes each connected to the distribution tank, but such a solution would give rise to even more assembly difficulties, in particular to make the tube corrugations and their respective ends coincide longitudinally, resulting in poor operation of such a dual-tube regulation device. Furthermore, the assembly of such a dual-tube regulation device would be more expensive than the assembly methods described above.

The inventors therefore designed another tube 6b of another regulation device, shown in FIG. 3, and also described in patent application FR3125636. This tube 6b comprises elements common to the tube 6, with the same references, in particular a first circulation assembly 21 and a second circulation assembly 23 connected by a bridge of material forming a sealing zone 48b on an end face 12b of the tube 6b. The distribution tank of this other regulation device is identical to that described previously in relation to the tube 6.

The bridge of material connecting the two circulation assemblies 21, 23 is less thick than the central strip of material of the tube 6. As a result, the tube 6b has much lower thermal conduction between the first circulation assembly 21 and the second circulation assembly 23. However, during the manufacture of the tube 6b, an operation of transverse cutting of the tube 6b, which first emerges in the form of a profile element from an extrusion die, creates a longitudinal burr in the sealing zone 48b. To be specific, in order to avoid crushing the material forming the tube 6b and its channels 8, the cutting operation consists of a first pre-cutting step during which blades c1, c2 cut the profile element on either side in a transverse direction T, i.e. across the width of the tube 6b, then a second drawing step during which the tube 6b is separated longitudinally from the profile element. It is this second drawing step which causes the longitudinal burr in the sealing zone 48b, owing to the fact that this zone, centered in the thickness of the tube 6b, has not undergone the pre-cutting step. However, during the assembly method mentioned above, this longitudinal burr prevents any contact between the ribs 44 of the shells 11 of the distribution tank, and the sealing zone 48b on the end face 12b. The tube 6b therefore provides better thermal insulation between the first circulation assembly 21 and the second circulation assembly 23, but requires an additional cutting operation to remove the longitudinal burr before assembling the tube 6b with the distribution tank to allow contact between the ribs 44 and the sealing zone 48b on the end face 12b.

This nevertheless requires a significant tolerance between the first corrugation of the tube 6b and the pipes of the distribution tank. If the longitudinal burr is not removed, then it is necessary to increase the tolerance necessary between a first corrugation of the tube 6b and the center of the pipes 18a, 18b, which is detrimental to the assembly of the corresponding regulation device and/or its proper functioning.

There is therefore a need for a thermal regulation device for an energy storage system, comprising a first heat transfer fluid circulation assembly and a second heat transfer fluid circulation assembly combined in the same tube while limiting the thermal conductivity and the fluidic communication between these two circulation assemblies, and having simple assembly, adapted to allow good alignment with another similar thermal regulation device without requiring restrictive manufacturing tolerances.

The present invention aims to overcome at least partially the drawbacks of the prior art, by providing a thermal regulation device for an energy storage system, an energy storage system comprising such a device, a method for assembling such a device and a method for manufacturing a tube of such a device, in which the tube of the device comprises two heat transfer fluid circulation assemblies sufficiently insulated from one another thermally and fluidically, while reducing the manufacturing tolerances necessary in particular with respect to the tube of the thermal regulation device according to the invention.

To this end, the invention proposes a thermal regulation device for cooling and/or heating components the operation of which is sensitive to temperature, these components being intended in particular for energy storage and possibly being battery cells of electrical energy storage members, comprising:
a distribution tank configured to be connected to a fluid inlet pipe and to a fluid outlet pipe, the distribution tank comprising a fluid intake chamber adapted to be served by the inlet pipe and a fluid return chamber adapted to be served by the outlet pipe,
a tube with two fluid circulation assemblies rigidly secured by a bridge of material, each assembly comprising a plurality of circulation channels along which the heat transfer fluid circulates from one longitudinal end of the tube to the other, a first fluid circulation assembly in communication with the intake chamber and a second fluid circulation assembly in communication with the return chamber, the fluid circulation assemblies having, in cross section of the tube, long edges inscribed on two parallel straight lines, the bridge of material interrupting the continuity of material on at least one of the parallel straight lines by forming at least one longitudinal absence of material on the tube,
the thermal regulation device being characterized in that the distribution tank comprises at least one rib separating the intake chamber from the return chamber, a part of the rib being housed in the absence of material at a junction zone of the tube with respect to the distribution tank and in that the bridge of material comprises a notch opening out on an end face of the tube, the distribution tank comprising a longitudinal bulge forming a protrusion from the rib and housed at least partially in the notch.

“In communication with the intake or return chamber” of course means fluidic communication, the fluid being able to pass from a circulation assembly to one of these chambers. The fluid is notably a heat transfer fluid such as glycol water. Furthermore, in this application, the term “longitudinal” relates to a longitudinal direction which is understood to be the direction along the main dimension of extension of the tube, i.e. in the direction of its length. Similarly, a transverse direction means a direction orthogonal to the longitudinal direction, oriented in the direction of the width of the tube, that is to say parallel to the long edges of the cross section of the tube which is made in a plane orthogonal to the longitudinal direction. Each of these long edges is inscribed on a straight line parallel to a straight line on which the other long edge is inscribed. The term “parallel” will of course be understood to mean “substantially parallel” owing to manufacturing tolerances, i.e. to within +/−5 degrees.

The tube of the thermal regulation device according to the invention therefore has transversely an oblong section allowing a cutting operation as described in the prior art. In particular, preferably, the circulation assemblies of the tube each have an alignment of channels between their long edges, the thickness of the tube at each circulation assembly, therefore orthogonal to the longitudinal and transverse directions, accommodating only one channel. The tube therefore has a thin section extending across the width of the tube, allowing good thermal conduction with cells of a storage system in which the thermal regulation device is used. As explained in relation to the prior art, the tube may have corrugations (or undulations) allowing good contact with these cells when they are cylindrical. Furthermore, the width of the tube is generally dictated by the size of the cells to be cooled, for example the height of their cylindrical shape if the thermal regulation device is housed between two rows of cells. If each row of cells has n superimposed cylindrical cells, the height to be taken into account can of course be multiplied by the same factor n. Each tube width thus defined for a storage system imposes dimensions and a number of channels in the fluid circulation assemblies, which number may be identical or different in each of these fluid circulation assemblies. In particular, these dimensions take into account the mechanical strength of the tube, vis-à-vis a maximum pressure of the fluid circulating in the channels of several bar, and take into account the thermal performance of the tube, in order to efficiently cool or heat the cells, with very good thermal homogeneity between the various channels of the same fluid circulation assembly.

Lastly, the tube of the thermal regulation device according to the invention is preferably formed by extrusion and its cross section is therefore preferably identical over the entire length of the tube, except at its end comprising the notch, produced for example during a step of cutting an extruded profile element of the tube. Alternatively, the tube is machined, and the bridge of material is not present over the entire longitudinal length of the tube, but over certain portions of this length and in particular at the end of the tube. The bridge of material is thinner than the strip of material in the prior art shown in FIG. 2. The bridge of material is in one piece and has only two ends transverse to the tube, for example having a cross section similar to that in FIG. 3.

By virtue of the invention, the assembly of the thermal regulation device according to the invention does not require great precision in the dimensioning of the end of the tube in relation to a first corrugation of the tube or more generally to a first surface provided for contact with an element to be cooled, the first corrugation or contact surface being that closest to the distribution tank. To be specific, the creation of the notch at the end of the bridge of material makes it possible to eliminate the longitudinal burr created when the tube is cut, which allows better control of the relative positions of the distribution tank and the tube. In addition, the longitudinal bulge inserted in the notch makes it possible to greatly limit the circulation of fluid between the first circulation assembly and the second circulation assembly whatever the longitudinal position of the longitudinal bulge in the notch, since this circulation will be controlled by the transverse position of the longitudinal bulge relative to the side walls of the circulation assemblies flanking same.

When the notch extends from one of the side walls to the other, and when the longitudinal bulge follows the shapes of the side walls, the seal between the circulation assemblies of the tube is complete. Note that the longitudinal bulge extending orthogonally to the transverse and longitudinal directions may therefore coincide with the rib if this rib stops longitudinally at an end wall of the notch.

Preferably, however, since the absence of material forms on the tube a groove extending longitudinally over the tube, the rib fills the groove over a longitudinal portion of the bridge of material, and the longitudinal bulge forms a longitudinal stop adapted to come up against the end wall of the notch, the bulge starting on the rib in the notch and ending at a longitudinal end of the distribution tank on the side opposite the tube.

Lastly, because the bridge of material is thin in relation to the thickness of the tube, the thermal conduction between the first circulation assembly and the second circulation assembly is very limited.

Preferably in the invention, a distance between a lateral edge of the longitudinal bulge and a lateral edge of the notch is between 0.02 and 0.2 times a width of the notch. This distance is the easiest to control in terms of chain of dimensions and ensures a low circulation of fluid between the circulation assemblies even when the longitudinal bulge is quite far from an end wall of the notch, orthogonal to the lateral edges of the notch. The width of the notch is of course the transverse distance between the lateral edges of the notch. These dimensions make it possible to limit an internal leak between the first circulation assembly and the second circulation assembly, in such a way as to maintain acceptable thermal efficiency of the thermal regulation device according to the invention.

In one embodiment of the invention, the distance between an end edge of the longitudinal bulge and the end wall of the notch is not zero but is smaller than the distance between the end face of the tube and the end edge of the longitudinal bulge, these distances being measured longitudinally, and therefore in the direction of the length of the tube. This further limits the passage of fluid from one circulation assembly to another, especially when the contours of the longitudinal bulge are rounded, which is the case when the distribution tank is formed partially by stamping. Preferably, therefore, the distance between the end face of the tube and the end edge of the longitudinal bulge, when the tube is inserted in the distribution tank, is greater than or equal to a radius of curvature characterizing a rounded edge between a lateral edge of the longitudinal bulge and the end edge of the longitudinal bulge.

Alternatively, the longitudinal bulge is in contact with the bridge of material on the end wall of the notch, preventing any circulation of fluid between the circulation assemblies or limiting it as much as possible when the end edge of the longitudinal bulge is rounded. This is because the longitudinal bulge makes it possible to cover the entire thickness of the tube, possibly in collaboration with another longitudinal bulge or another rib as explained below.

According to an optional feature of the invention, the distribution tank comprises a receiving portion having a shape complementary to a longitudinal end portion of the tube in the junction zone, the longitudinal end of the tube being fitted in the receiving portion. This complementary shape, achieved in particular by virtue of the ribs mentioned above, ensures sealing between the distribution tank and the tube. For example, the tube is brazed to the distribution tank once the tube is inserted therein.

The recesses forming the chambers on the one hand, and the ribs on the other hand, are easily formed by stamping metal plates each forming one of the two shells, which are then brazed or welded to one another to form the distribution tank. Likewise, the bulge(s) of the ribs are preferably formed by stamping and therefore do not necessarily correspond to an excess of material on the ribs, but to an extension of this material in the direction of the thickness of the distribution tank. The shells are preferably in one piece. The ribs are alternatively formed by deformation of the sheet metal, or by an excess of material.

The ribs contribute to sealing between the distribution chambers by longitudinally separating the two recesses on each of the shells. When the tube is inserted in the distribution chamber, the ribs with the longitudinal bulge(s) form a central wall separating the two chambers over a longitudinal portion of the distribution tank over its entire thickness, and fill the absences of material formed by the bridge of material over another longitudinal portion of the distribution tank covering the junction zone, in such a way as to ensure sealing between the tube and the distribution tank. To be specific, the ribs extend longitudinally from an edge of each shell corresponding to a longitudinal end of the receiving portion, in contact with the bridge of material, to an unstamped area of the shell extending to the opposite edge of the shell. The unstamped areas of the shells are pressed against one another when the shells are assembled and then brazed, thus extending the seal between the two chambers longitudinally to the opposite edge of each shell. In this arrangement, the ribs therefore extend longitudinally beyond the walls of the bridge of material from the tube toward the distribution tank.

According to an optional feature of the invention, the bridge of material connects the two circulation assemblies, forming two absences of material on the tube, each corresponding to a longitudinal groove on the tube. The tube is preferably made of metal, such as aluminum, and formed by extrusion then cutting.

According to an optional feature of the invention, the distribution tank is formed by two shells attached to one another, each shell comprising a first recess forming one half of the intake chamber and a second recess forming one half of the return chamber. The distribution tank is preferably also made of metal, for example aluminum. Unlike the tube, the distribution tank is preferably produced by stamping. Alternatively, the distribution tank is machined. Materials other than aluminum are of course possible for the tube and the distribution tank, provided that they are thermally conductive and have sufficient mechanical strength to avoid deforming under the pressure of the heat transfer fluid.

According to an optional feature of the invention, the distribution tank comprises a rib on each shell, the rib separating the intake chamber from the return chamber and filling, at least over the junction zone, one of the longitudinal grooves, the rib having on top a longitudinal bulge housed at least partially in the notch, the longitudinal bulges being in contact with one another.

According to an optional feature of the invention, the distribution tank comprises a rib on each shell, the rib separating the intake chamber from the return chamber and filling, at least over the junction zone, one of the longitudinal grooves, the rib on one of the shells having on top a longitudinal bulge housed at least partially in the notch, said longitudinal bulge being in contact with the rib on the other of the shells.

The invention also relates to a system comprising several components the operation of which is sensitive to temperature, in particular assemblies of electrical energy storage members, and at least one thermal regulation device according to the invention, the tube of the thermal regulation device being closed, on the side opposite the distribution tank of the thermal regulation device, by a return tank of the thermal regulation device, the return tank placing the first fluid circulation assembly in communication with the second fluid circulation assembly. The thermal regulation devices are preferably arranged between each row of electrical energy storage members in the system. Alternatively or in addition, thermal regulation devices are each arranged on one of the main faces of the system according to the invention, the main faces being the faces of largest dimensions, on either side of the system.

According to an optional feature of the invention, a first and a second thermal regulation devices of the system are configured to be sealingly connected by direct interaction between a service pipe connected to the intake chamber of the first thermal regulation device and the inlet pipe connected to the intake chamber of the second thermal regulation device, and between the outlet pipe connected to the return chamber of the second thermal regulation device and a discharge pipe connected to the return chamber of the first thermal regulation device.

The invention also relates to a manufacturing method for manufacturing a thermal regulation device according to the invention, comprising:
a step of manufacturing by extrusion of a profile element of the tube of the thermal regulation device, forming the circulation assemblies and the bridge of material of the tube, the latter not yet being provided with a notch,
a step of pre-cutting a part of the profile element of the tube along parallel straight lines at a location spaced apart longitudinally, by a length of the tube, from a longitudinal end of the profile element of the tube,
a step of separating the pre-cut part by longitudinally separating the pre-cut part from a non-pre-cut part of the profile element of the tube, delivering the tube without a notch, and
a step of cutting the notch on one end of the bridge of material of the tube obtained from the previous step.

The invention also relates to an assembly method for assembling a thermal regulation device according to the invention, during which:
the distribution tank is formed by assembly of the two shells one against the other,
the longitudinal end of the tube provided with the junction zone is inserted into the distribution tank until the longitudinal bulge of one of the ribs is at least partially housed in the notch, and
the assembly formed by the distribution tank and the tube is brazed.

In the assembly method according to the invention, the tube is obtained for example according to the manufacturing method according to the invention.

In a first variant of the assembly method according to the invention, the tank or the tube are moved against one another until the longitudinal bulge is in contact with the end wall of the notch.

In a second variant of the assembly method according to the invention, the longitudinal end of the tube provided with the junction zone is inserted into the distribution tank by moving the latter until it stops against a stop external to the thermal regulation device and placed at a predetermined distance from a first corrugation of the tube, between this first corrugation and the longitudinal end face of the tube. Thus, the distance between the first corrugation and the pipes of the distribution tank is controlled. Of course, if the tube does not have corrugations but has thermal contact zones of other shapes, the external stop will be placed between an indexed position of this thermal contact zone and the longitudinal end face of the tube. In this second variant, the length of the longitudinal end inserted in the distribution tank does not generally correspond to contact between the longitudinal bulge and the end wall of the notch, but the distance between the lateral edges of the longitudinal bulge and the lateral edges of the notch is controlled in such a way as to dimension in an acceptable manner the slight internal leak resulting from this second variant of the assembly method according to the invention, between the first fluid circulation assembly and the second circulation assembly. This second variant makes it possible to do away with a link in the chain of dimensions, notably between an element of the distribution tank and the longitudinal end face of the tube.

Other features and advantages of the invention will become more clearly apparent both from the following description and from a number of examples of embodiments provided by way of non-limiting indication with reference to the appended schematic drawings, in which:

FIG. 1, already discussed in relation to the prior art, shows a perspective view of a part of a tube and a distribution tank of a thermal regulation device of an energy storage system,

FIG. 2 shows a perspective view of an end face of the tube of FIG. 2,

FIG. 3, also already discussed in relation to the prior art, shows a view of an end face of a tube of another thermal regulation device of an energy storage system,

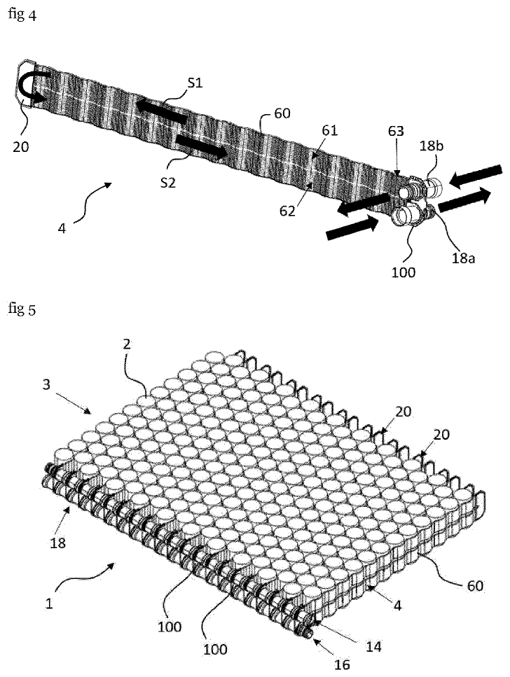

FIG. 4 shows a perspective view of a thermal regulation device according to the invention, in one embodiment of the invention,

FIG. 5 shows a perspective view of an electrical energy storage system according to the invention, in this embodiment of the invention,

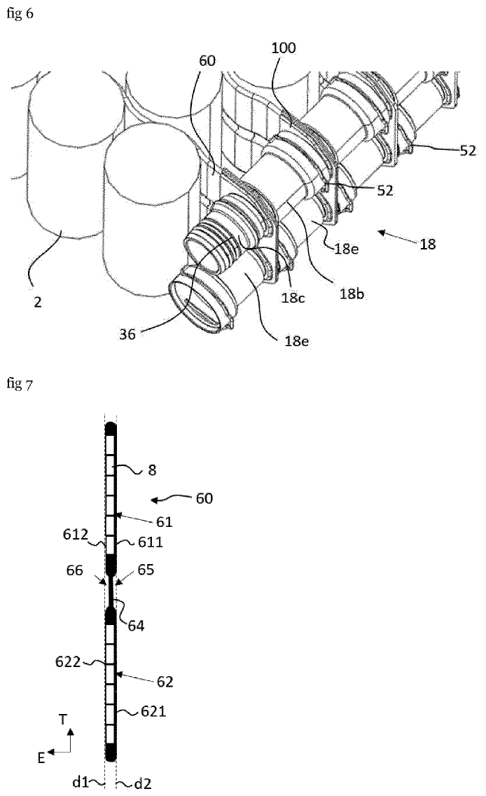

FIG. 6 shows a close-up perspective view of the fluidic connections between several thermal regulation devices of the electrical energy storage system of FIG. 5,

FIG. 7 shows in cross section an end face of a tube of the thermal regulation device of FIG. 4, the cross section being made through a solid part of a bridge of material connecting two fluid circulation assemblies of the tube,

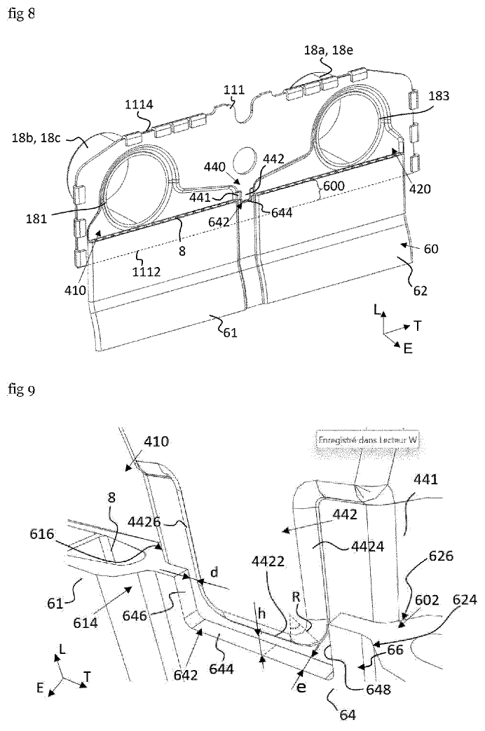

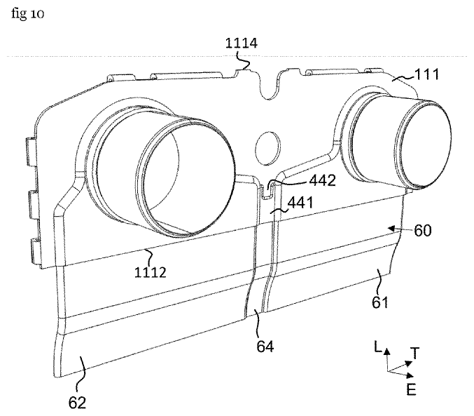

FIG. 8 is a perspective view of an end portion of the tube of FIG. 7, fitted in a distribution tank of the thermal regulation device of FIG. 4, formed of two shells assembled one on top of the other, one of the shells not being depicted in order to show the end face of the tube in the distribution tank,

FIG. 9 is an enlargement of FIG. 8 at an end face of the tube, giving a clearer view of a notch in the bridge of material opening out on this end face, as well as a longitudinal bulge of the shell shown in FIG. 8 and housed partially in the notch,

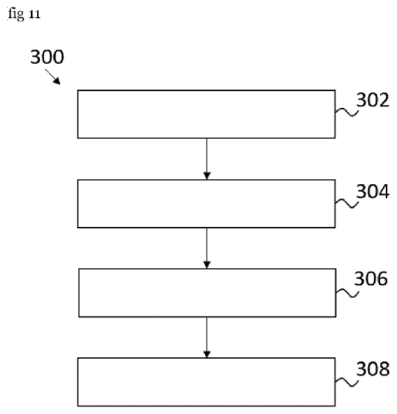

FIG. 10 is a perspective view from a point of view opposite to that in FIG. 8, showing the outer face of the shell and a part of the tube extending outside the shell,

FIG. 11 shows steps in a method for manufacturing a tube of a thermal regulation device according to the invention, in one embodiment of the invention, and

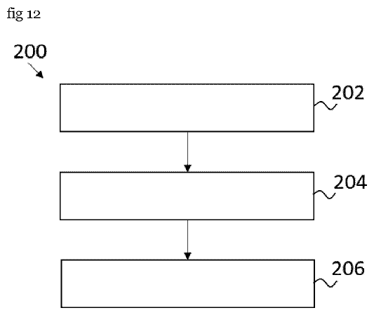

FIG. 12 shows steps in a method for assembling a thermal regulation device according to the invention, in one embodiment of the invention.

FIG. 4 depicts an embodiment of a thermal regulation device 4 according to the invention, comprising an aluminum tube 60, one longitudinal end of which is fitted in a distribution tank 100 and the other longitudinal end of which is fitted in a return tank 20. To be specific, in this thermal regulation device 4, the circulation of the fluid is referred to as U-type circulation, that is to say with the same portion of heat transfer fluid circulating in two opposite directions S1, S2 of circulation within the tube 60. The thermal regulation device 4 comprises corrugations to optimize its surface area for exchange with cylindrical battery cells. In particular, a first corrugation 63 of the tube is positioned such that the pipes of the distribution tank 100 are coaxial with other pipes of another distribution tank 100, as explained below.

More specifically, the heat transfer fluid arrives in the thermal regulation device 4 via an inlet pipe 18b sealingly connected to an intake chamber 410 (referenced in FIG. 8) of the distribution tank 100, enters a first circulation assembly 61 of the tube 60, and circulates in the first direction Si to the return tank 20, which sends it to a second circulation assembly 62 of the tube 60. Once in the second circulation assembly 62, the heat transfer fluid circulates in the second direction S2 to a return chamber 420 (referenced in FIG. 8) of the distribution tank 100, then leaves via an outlet pipe 18a sealingly connected to the return chamber 420. As described in more detail below in relation to FIG. 6, other pipes coaxial with the inlet pipes 18b and outlet pipes 18a are provided on the distribution tank 100, to communicate fluidically with other distribution tanks of other thermal regulation devices according to the invention.

The thermal regulation device 4 is in fact used to cool an electrical energy storage system 1 shown in FIG. 5, intended in particular to equip an electric or hybrid vehicle. This electrical energy storage system 1 comprises several electrical energy storage devices 2, in this case cylindrical cells 2, which accumulate energy, and are electrically connected to one another in series.

The cylindrical cells 2 are arranged vertically, in other words perpendicular to the plane in which the electrical energy storage system mainly lies.

The electrical energy storage system 1 comprises several thermal regulation devices 4 each comprising a tube 60, arranged between two rows 3 of cylindrical cells 2, or bordering such a row 3 at the edge of the energy storage system 1, in such a way as to allow heat exchange between the thermal regulation devices 4 and the cylindrical cells 2. The tubes 60 are corrugated to provide an optimal surface for exchange with the cylindrical cells 2. They are made of aluminum, for example.

The arrangement of the thermal regulation devices 4 is such that the return tanks 20 of the thermal regulation devices 4 are located on the same side of the energy storage system 1, outside the rows 3 of cylindrical cells 2. Likewise, the distribution tanks 100 of the thermal regulation devices 4 are all located on the opposite side of the energy storage system 1, outside the rows 3 of cylindrical cells 2. As a result, a connection system 18, described in detail below, makes it possible to connect all the distribution tanks 100 together, such that they can receive a heat transfer fluid coming from the same heat transfer fluid intake 14 for the entire energy storage system 1, and such that this heat transfer fluid can be discharged through the same heat transfer fluid discharge outlet 16 for the entire energy storage system 1.

As can be seen in FIG. 6, the connection system 18 provides, for each thermal regulation device 4 between two rows 3 of cylindrical cells 2:
an inlet pipe 18b serving the intake chamber 410 of the distribution tank 100 of the thermal regulation device 4,
an outlet pipe 18a, referenced in FIG. 4 and not visible in FIG. 6 because it is housed in another pipe of the adjacent tube, said outlet pipe being served by the return chamber 420 of the distribution tank 100 of the thermal regulation device 4,
a service pipe 18c adapted to be fitted in an inlet pipe 18b of a distribution tank 100 of a thermal regulation device 4 adjacent to the thermal regulation device 4 comprising this service pipe 18c, and
a discharge pipe 18e adapted to receive an outlet pipe 18a of a distribution tank 100 of a thermal regulation device 4 adjacent to the thermal regulation device 4 comprising this discharge pipe 18e.

Each service pipe 18c includes in particular an O-ring 36 making it possible to ensure that it fits sealingly in an inlet pipe 18b, and each outlet pipe 18a includes an O-ring making it possible to ensure that it fits sealingly in a discharge pipe 18e. The seals 36 are held in place, clamped radially by the fitting of the corresponding pipes, which are held one inside the other by the presence of a ring 52 preventing their relative axial movement.

Of course, other connection options exist and can be used as an alternative.

The tube 60 in this embodiment of the invention is shown in FIG. 7, seen in cross section, i.e. in a plane orthogonal to a longitudinal direction oriented along the length of the tube 60, in a solid part of a bridge of material 64 connecting the first fluid circulation assembly 61 of the tube 60, and the second fluid circulation assembly 62 of the tube 60.

This cross section shows the tube 60, on the one hand across its width, corresponding to the largest dimension of the tube 60 in this cross section, and in the direction of alignment of the channels 8 relative to one another in each fluid circulation assembly 61, 62, and on the other hand across its thickness, in a direction orthogonal to the width of the tube.

The width of the tube 60 is oriented in a transverse direction T and the thickness of the tube 60 in a direction E.

Similar to FIG. 3, the channels 8 are each separated by a wall 50 in the width direction of the tube 60. As shown, the tube 60 is very thin, of the order of a few millimeters, and a single channel 8 may be housed in the direction of the thickness of the tube 60, which allows the tube 60 to be cut at the outlet of an extrusion die in a first pre-cutting step followed by a second drawing step.

The first fluid circulation assembly 61 therefore has, across the width of the tube 60 in this cross section, a first long edge 612 which is inscribed on a first straight line d1, and an opposite second long edge 611 which is inscribed on a second straight line d2 substantially parallel to the first straight line d1.

Likewise, the second fluid circulation assembly 62 has, across the width of the tube 60 in this cross section, a first long edge 622 which is inscribed on the first straight line d1, and a second long edge 621 which is inscribed on the second straight line d2.

The bridge of material 64 interrupts the continuity of material on the parallel straight lines d1, d2, forming a first absence of material 66 between the two edges 612, 622 on a first longitudinal face of the tube 60, and a second absence of material 65 between the two edges 611, 621 on a second longitudinal face of the tube 60 opposite the first longitudinal face of the tube 60.

Since the tube 60 is formed by extrusion, in this embodiment of the invention, these absences of material 65, 66 extend over the entire length of the tube, forming longitudinal grooves open to the outside of the tube 60, between the circulation assemblies 61, 62.

Unlike the embodiment presented in relation to FIG. 3, the tube 60 comprises a notch 642, visible in FIG. 8, formed in these longitudinal grooves and opening out on an end face 602 (referenced in FIG. 9) of the tube 60. The end face 602 is a flat surface comprising the opening of the channels 8 of the circulation assemblies 61, 62. It is parallel, at the notch 642, to an end wall 644 of the notch 642. The notch 642 interacts with sealing means 440 of the distribution tank 100 when the tube 60 is inserted in the distribution tank 100, now described in relation to FIG. 8.

In FIG. 8, a longitudinal direction L, to which the term “longitudinal” refers, is oriented along the length of the tube 60, orthogonal to the transverse direction T oriented across the width of the tube 60, and to the direction E oriented across the thickness of the tube 60. These directions are also used to position the distribution tank 100 in FIGS. 8 to 10. In particular, the largest dimension of the distribution tank 100 is oriented in the transverse direction T, this largest dimension being oriented in the direction of the width of the tube 60 when the latter is fitted in the distribution tank 100. Likewise, an intermediate dimension of the distribution tank 100, oriented in the direction of insertion of the tube 60, is oriented in the longitudinal direction L, and the smallest dimension or thickness of the distribution tank 100 is oriented in the direction E.

The distribution tank 100 is formed of two shells 111 assembled against one another and then brazed. Lateral hooking tabs on one of the shells allow the shells 111 to be held together during brazing. The distribution tank 100 is made of aluminum, in this embodiment of the invention. Alternatively, it may of course be made of another material, metal or polymer for example.

Each shell 111 comprises a first recess forming one half of the intake chamber 410 and a second recess forming one half of the return chamber 420. These recesses are formed by stamping, for example.

Each first recess is pierced with a hole bordered by a cylindrical base 181 intended to receive either an inlet pipe 18b or a service pipe 18c.

Likewise, each second recess is pierced with a hole bordered by a cylindrical base 183 intended to receive either an outlet pipe 18a or a discharge pipe 18e.

The distribution tank 100 extends longitudinally from a junction edge 1112 of each shell 111 with respect to the tube 60, therefore proximal to the tube 60, to a free edge 1114 of each shell, opposite the junction edge 1112, therefore distal to the tube 60. The distribution tank 100 comprises a receiving portion having a shape complementary to at least one longitudinal portion of a junction zone 600 on the end of the tube 60, this junction zone being fitted in this receiving portion, when the tube 60 is inserted in the distribution tank 100. The receiving portion is complementary to the junction zone 600 at least over the longitudinal portion of this junction zone 600 extending longitudinally from the junction edge 1112 of each shell 111 to the end wall 644 of the notch.

As can be seen in particular in FIG. 8, the intake chamber 410 and return chamber 420 follow the contours of the first circulation assembly 61 and the second circulation assembly 62 respectively, over the entire junction zone, through the shape of the first recesses of the intake chamber 410 on the one hand and the shape of the second recesses of the return chamber 420 on the other hand.

Each shell 111 further comprises a rib 441 separating the two chambers and following the shape of one of the absences of material 65, 66 longitudinally over the entire junction zone 600. In other words, each rib 441 of a shell 111 fills an end portion of a longitudinal groove formed by an absence of material 65, 66, such that the shells 111 grip the bridge of material 64 pincer-style at the junction zone 600. Owing to the planes of contact between each rib 441 and the bridge of material 64, parallel to the transverse T and longitudinal L directions, the ribs 441 do not fill the notch 642 in the junction zone 600, in this embodiment of the invention. According to the invention, and as will be described in detail below, the notch 642 is partially occupied by a longitudinal bulge 442 forming on each rib 441 a protrusion in the direction E.

As can be seen in FIGS. 9 and 10 in particular, each longitudinal bulge 442 begins on the corresponding rib 441, via an end edge 4422 located at a distance from the junction edge 1112 of the shell 111, where the rib 441 begins, and extends longitudinally as far as the unstamped area of the shell 111 located between the two chambers 410, 420. The longitudinal distance between the start of the rib 441 and the start of the longitudinal bulge 442 makes it possible, thanks to the complementarity of the shapes of the ribs 441 and the bridge of material 64 over this distance, to ensure sealing between the tube 60 and the distribution tank 100. The longitudinal bulges 442 and the ribs 441 also form the sealing means 440 between the two chambers.

The ribs 441, formed for example by stamping, contribute to separating the intake chamber 410 from the return chamber 420, by forming a central wall between these two chambers, and therefore contribute to sealing between the intake chamber 410 and the return chamber 420.

The ribs 441 extend longitudinally between the two chambers from the junction edge 1112 of each shell 111, to an unstamped area of the shell 111 extending in the vicinity of the free edge 1114 of the shell 111. The unstamped areas of the shells 111 are pressed against one another when the shells 111 are assembled and then brazed, thus extending the seal between the two chambers longitudinally to the free edge 1114 of each shell 111.

The ribs 441 have a thickness extending over the shell 111 in the direction E as far as the bridge of material 64 only, when the tube 60 is inserted in the distribution tank 100. Therefore, when the tube 60 is inserted in the distribution tank 100, they do not by themselves close the circulation of heat transfer fluid because they are, between the intake chamber 410 and the return chamber 420, separated by the thickness e (referenced in FIG. 9) of the bridge of material 64. The heat transfer fluid can therefore pass from the channels 8 of the second circulation assembly 62 on the end face 602 of the tube 60 to the end wall 644 of the notch 642, and circulate on this end wall 644 to the circulation channels 8 of the first circulation assembly 61, moving up the end face 602 of the tube 60. To prevent this free circulation of fluid through the notch, the longitudinal bulges 442 extend into the notch, forming a protrusion on their respective rib 441 in the direction E, until they meet one another and obstruct, at least partially, the notch.

However, as can be seen in FIG. 9, this sealing cannot be complete if the end edge 4422 does not touch the end wall 644 of the notch, or if neither of the lateral edges 4426, 4424 of the longitudinal bulge 442 touches one of the lateral edges 646, 648 of the notch 642, the lateral edges of the longitudinal bulge 442 and of the notch 642 extending in the longitudinal direction L. In a variant embodiment of the invention, the end edge 4422 of the longitudinal bulge 442 touches the end wall 644 of the notch, or one of the lateral edges 4426, 4424 of the longitudinal bulge 442 touches one of the lateral edges 646, 648 of the notch 642, the corresponding edge(s) of the bulge 442 having a flat surface parallel to the end wall 644 or to one of the lateral edges 646, 648 of the notch 642. In this variant, complete sealing is achieved between the circulation assemblies 61, 62.

However, in the embodiment of the invention presented in relation to FIGS. 8, 9 and 10, since the bulge 442 is produced by stamping, its edges are rounded, and as a result the sealing between the circulation assemblies 61, 62 is not complete but is sufficient thanks in particular to the control of the relative distances between the lateral edges 4426, 4424 of the longitudinal bulge 442 and the lateral edges 614, 616, 624, 626 of the circulation assemblies 61, 62.

In other words, even if sealing is not complete in this case, sufficient sealing is achieved provided that a restriction is created to slow down the circulation of the fluid, by inserting the bulge sufficiently into the notch. To this end, it is necessary for at least the end edge 4422 and the lateral ends of this end edge, these ends being rounded as a result of stamping, to be received in the notch.

In this embodiment of the invention, the width of the notch is smaller than the transverse distance between the two circulation assemblies 61, 62. As a result, the longitudinal bulge 442 itself has, at least over a longitudinal end portion, a width which is smaller than the width of the rib 441 the thickness of which it extends, such that it can be accommodated in the notch 642. The manufacturing tolerances of the shells 111 and the tube 60 allow a distance d between one of the lateral edges 4426, 4424 of the longitudinal bulge 442 and one of the lateral edges 646, 648 of the notch 642 to be between 0.02 and 0.2 times the width of the notch 642. As a guide, this distance d is around half a millimeter, and the width of the notch is around 4 millimeters. The largest dimension of the section of the internal leak between the two chambers is therefore of the order of half a millimeter, or four times smaller than in the prior art.

In a variant, the notch 642 extends transversely from the lateral edges 614, 616 of the first circulation assembly 61 to the lateral edges 624, 626 of the second circulation assembly 62. In this case, the distance d between one of the lateral edges 4426, 4424 of the longitudinal bulge 442 and one of the lateral edges 614, 616, 624, 626 of the circulation assemblies 61, 62 is between 0.02 and 0.2 times a distance between the lateral edges 614, 616 of the first circulation assembly 61 and the lateral edges 624, 626 of the second circulation assembly 62.

Furthermore, in this variant or in the embodiment of the invention, a distance h between the end edge 4422 of the longitudinal bulge 442 and the end wall 644 of the notch is smaller than the distance between the end face 602 of the tube 60 and the end edge 4422 of the bulge 442, these distances being measured in the longitudinal direction L. The distance h may be half a millimeter or several millimeters without the internal leak being greater in both cases, provided that the distance d is controlled and is identical, for example around half a millimeter. The longitudinal depth of the notch 642 is of course always greater than the distance h. It is approximately one to a few millimeters, and preferably at least half a millimeter greater than the distance h, so that the rounded shape of the contour of the bulge 442 does not promote the circulation of fluid between the space between the lateral edges 646, 648 of the notch 642 and the lateral edges 4426, 4424 of the longitudinal bulge 442 on the one hand, and the space between the end edge 4422 of the longitudinal bulge 442 and the end wall 644 on the other hand.

In other words, the distance between the end face 602 of the tube 60 and the end edge 4422 of the longitudinal bulge 442, when the tube 60 is inserted in the distribution tank 100, is greater than or equal to a radius of curvature R characterizing a rounded edge between a lateral edge 4424, 4426 of the longitudinal bulge and the end edge 4422 of the longitudinal bulge 442.

A manufacturing method 300 for manufacturing the tube 60 of the thermal regulation device 4 according to the invention will now be described in relation to FIG. 11. The manufacturing method 300 comprises:
a step of manufacturing 302 by extrusion of a profile element of the tube 60 of the thermal regulation device 4, forming the circulation assemblies 61, 62 and the bridge of material 64 of the tube 60, not yet provided with the notch 642,
a step of pre-cutting 304 a part of the profile element of the tube 60 thus manufactured, this pre-cutting being carried out transversely to the tube 60 along parallel straight lines d1, d2, at a location spaced apart longitudinally from an end of the profile element of the tube 60, by the length of the tube 60, and
a step of separating 306 the part thus pre-cut by longitudinally separating the pre-cut part from the rest of the profile element of the tube 60; the pre-cut and separated part forms a tube 60 of the thermal regulation device 4 without a notch.

Lastly, a final step is a step of cutting 308 the notch 642 on one end of the bridge of material 64 of the tube 60 without a notch, obtained from the separation step 306. Note that in this embodiment, each pre-cutting and separation step forms an end of the rest of the profile element of the tube 60, not yet pre-cut, which will be used to manufacture another tube.

Once the tube 60 has been manufactured, an assembly method 200 for assembling the thermal regulation device 4 according to the invention, shown in FIG. 12, is implemented.

In a first step 202 of the assembly method 200, the distribution tank 100 is formed by superimposing the two shells 111 one against the another.

Then, in a second step 204 of the assembly method 200, a longitudinal end of the tube 60 is inserted into the distribution tank 100 until the longitudinal bulges 442 on the ribs 441 of the shells 411 are housed at least partially in the notch 642 of the bridge of material 64.

Lastly, in a third step 206, the assembly formed by the distribution tank 100 and the tube 60 thus inserted in the distribution tank 100, is brazed.

In the second step 204, the tube 60 is inserted for example into the distribution tank 100 until the end edge 4422 of the longitudinal bulge 442 reaches the end wall 644 of the notch. This makes it possible to limit the circulation of fluid between the two chambers 410, 420 of the distribution tank 100 as much as possible.

As a variant, in particular if it is desired to do away with a link in the chain of dimensions between the longitudinal end of the tube 60 and a first corrugation 63 of the tube 60 proximal to this longitudinal end, during the second step 204, the longitudinal end of the tube 60 is inserted into the distribution tank 100 by bringing the latter against a stop external to the thermal regulation device 4 and placed at a predetermined distance between the first corrugation 63 of the tube 60 and its longitudinal end. This variant generally does not ensure contact between the end edges 4422 of the longitudinal bulges 442 and the end wall 644 of the notch 642. However, any internal leak that occurs is controlled.

Of course, the invention is not limited to the examples that have just been described, and numerous modifications can be made to these examples without departing from the scope of the invention. In particular, the features of the different embodiments or variants can be combined to carry out the invention, provided that these embodiments or variants are not mutually incompatible.

1. A thermal regulation device for cooling and/or heating components the operation of which is sensitive to temperature, these components being intended in particular for energy storage and possibly being battery cells of electrical energy storage members, comprising:
a distribution tank configured to be connected to a fluid inlet pipe and to a fluid outlet pipe, the distribution tank comprising a fluid intake chamber adapted to be served by the inlet pipe and a fluid return chamber adapted to be served by the outlet pipe,
a tube with two fluid circulation assemblies rigidly secured by a bridge of material, each assembly comprising a plurality of circulation channels along which the heat transfer fluid circulates from one longitudinal end of the tube to the other, a first fluid circulation assembly in communication with the intake chamber and a second fluid circulation assembly in communication with the return chamber, the fluid circulation assemblies having, in cross section of the tube, long edges inscribed on two parallel straight lines, the bridge of material interrupting the continuity of material on at least one of the parallel straight lines forming at least one longitudinal absence of material on the tube,
the thermal regulation device being wherein the distribution tank comprises at least one rib separating the intake chamber from the return chamber, a part of the rib being housed in the absence of material at a junction zone of the tube with respect to the distribution tank and in that the bridge of material comprises a notch opening out on an end face of the tube, the distribution tank comprising a longitudinal bulge forming a protrusion from the rib and housed at least partially in the notch.

2. The thermal regulation device as claimed in claim 1, wherein a distance between a lateral edge of the longitudinal bulge and a lateral edge of the notch is between 0.02 and 0.2 times a width of the notch.

3. The thermal regulation device as claimed in claim 12, wherein the distribution tank comprises a receiving portion having a shape complementary to a longitudinal end portion of the tube in the junction zone, the longitudinal end of the tube being fitted in the receiving portion.

4. The thermal regulation device as claimed in claim 1, wherein the bridge of material connects the two circulation assemblies, forming two absences of material on the tube, each corresponding to a longitudinal groove on the tube.

5. The thermal regulation device as claimed in claim 1, wherein, the distribution tank being formed by two shells attached to one another, each shell comprises a first recess forming one half of the intake chamber and a second recess forming one half of the return chamber.

6. The thermal regulation device as claimed in claim 5, wherein the distribution tank comprises a rib on each shell, the rib separating the intake chamber from the return chamber and filling, at least over the junction zone, one of the longitudinal grooves, the rib having on top a longitudinal bulge housed at least partially in the notch, the longitudinal bulges being in contact with one another.

7. The thermal regulation device as claimed in claim 5, wherein the distribution tank comprises a rib on each shell, the rib separating the intake chamber from the return chamber and filling, at least over the junction zone, one of the longitudinal grooves, the rib on one of the shells having on top a longitudinal bulge housed at least partially in the notch, said longitudinal bulge being in contact with the rib on the other of the shells.

8. A system comprising several components the operation of which is sensitive to temperature, in particular assemblies of electrical energy storage members and at least one thermal regulation device as claimed in claim 1, the tube of the thermal regulation device being closed, on the side opposite the distribution tank of the thermal regulation device, by a return tank of the thermal regulation device, the return tank placing the first fluid circulation assembly in communication with the second fluid circulation assembly.

9. The system as claimed in claim 8, of which a first and a second thermal regulation devices are configured to be sealingly connected by direct interaction between a service pipe connected to the intake chamber of the first thermal regulation device and the inlet pipe connected to the intake chamber of the second thermal regulation device, and between the outlet pipe connected to the return chamber of the second thermal regulation device and a discharge pipe connected to the return chamber of the first thermal regulation device.

10. An assembly method for assembling a thermal regulation device as claimed in claim 1, during which:
the distribution tank is formed by assembly of the two shells one against the other,
the longitudinal end of the tube provided with the junction zone is inserted into the distribution tank until the longitudinal bulge of one of the ribs is at least partially housed in the notch, and
the assembly formed by the distribution tank and the tube is brazed.

11. A manufacturing method for manufacturing a thermal regulation device as claimed in claim 1, comprising:
a step of manufacturing by extrusion, of a profile element of the tube of the thermal regulation device forming the circulation assemblies and the bridge of material of the tube, the latter not yet being provided with a notch,
a step of pre-cutting a part of the profile element of the tube along parallel straight lines at a location spaced apart longitudinally, by a length of the tube, from a longitudinal end of the profile element of the tube,
a step of separating (306) the pre-cut part by longitudinally separating the pre-cut part from a non-pre-cut part of the profile element of the tube, delivering the tube without a notch, and
a step of cutting the notch on one end of the bridge of material of the tube obtained from the previous step.

12. The thermal regulation device as claimed in claim 2, wherein the distribution tank comprises a receiving portion having a shape complementary to a longitudinal end portion of the tube in the junction zone, the longitudinal end of the tube being fitted in the receiving portion.

13. The thermal regulation device as claimed in claim 2, wherein the bridge of material connects the two circulation assemblies, forming two absences of material on the tube, each corresponding to a longitudinal groove on the tube.

14. The thermal regulation device as claimed in claim 2, wherein, the distribution tank being formed by two shells attached to one another, each shell comprises a first recess forming one half of the intake chamber and a second recess forming one half of the return chamber.

15. A system comprising several components the operation of which is sensitive to temperature, in particular assemblies of electrical energy storage members, and at least one thermal regulation device as claimed in claim 2, the tube of the thermal regulation device being closed, on the side opposite the distribution tank of the thermal regulation device, by a return tank of the thermal regulation device, the return tank placing the first fluid circulation assembly in communication with the second fluid circulation assembly.

16. An assembly method for assembling a thermal regulation device as claimed in claim 2, during which:
the distribution tank is formed by assembly of the two shells one against the other,
the longitudinal end of the tube provided with the junction zone is inserted into the distribution tank until the longitudinal bulge of one of the ribs is at least partially housed in the notch, and
the assembly formed by the distribution tank and the tube is brazed.

17. A manufacturing method for manufacturing a thermal regulation device as claimed in claim 2, comprising:
a step of manufacturing by extrusion, of a profile element of the tube of the thermal regulation device, forming the circulation assemblies and the bridge of material of the tube, the latter not yet being provided with a notch,
a step of pre-cutting a part of the profile element of the tube along parallel straight lines at a location spaced apart longitudinally, by a length of the tube, from a longitudinal end of the profile element of the tube,
a step of separating the pre-cut part by longitudinally separating the pre-cut part from a non-pre-cut part of the profile element of the tube, delivering the tube without a notch, and
a step of cutting the notch on one end of the bridge of material of the tube obtained from the previous step.

18. The thermal regulation device as claimed in claim 3, wherein the bridge of material connects the two circulation assemblies, forming two absences of material on the tube, each corresponding to a longitudinal groove on the tube.

19. The thermal regulation device as claimed in claim 3, wherein, the distribution tank being formed by two shells attached to one another, each shell comprises a first recess forming one half of the intake chamber and a second recess forming one half of the return chamber.

20. A system comprising several components the operation of which is sensitive to temperature, in particular assemblies of electrical energy storage members, and at least one thermal regulation device as claimed in claim 3, the tube of the thermal regulation device being closed, on the side opposite the distribution tank of the thermal regulation device, by a return tank of the thermal regulation device, the return tank placing the first fluid circulation assembly in communication with the second fluid circulation assembly.
